(19) United States
(12) Patent Application Publication
(10) Pub. No.: US 2026/0252467 A1
(43) Pub. Date: Aug. 27, 2026

(54) CONDITIONAL TRACING OF OPERATION FLOWS EXECUTING ON INFORMATION TECHNOLOGY ASSETS

(71) Applicant: Dell Products L.P., Round Rock, TX (US)

(72) Inventors: Gadi Ickowicz, Modiin (IL); Vladimir Shveidel, Pardes-Hana (IL)

(21) Appl. No.: 19/059,612

(22) Filed: Feb. 21, 2025

(51) Int. Cl. G06F 11/362

(52) U.S. Cl. CPC G06F 11/3636

(57) ABSTRACT

An apparatus comprises at least one processing device configured to generate, for operations of an operation flow executing in an information technology asset, first and second sets of traces, the second set of traces having more detail than the first set of traces, and to maintain, while the operation flow is executing, the second set of traces in a trace buffer allocated for the operation flow. The at least one processing device is also configured to determine whether any designated conditions are detected during execution of the operation flow and, responsive to detecting any of the designated conditions, to save the second set of traces in a persistent data store. The at least one processing device is further configured, responsive to not detecting any of the designated conditions, to drop the trace buffer allocated for the operation flow and save the first set of traces in the persistent data store.

### BACKGROUND

Support platforms may be utilized to provide various services for sets of managed computing devices. Such services may include, for example, troubleshooting and remediation of issues encountered on computing devices managed by a support platform. This may include periodically collecting information on the state of the managed computing devices (e.g., in the form or logs or other traces), and using such information for troubleshooting and remediation of the issues. Such troubleshooting and remediation may include receiving requests to provide servicing of hardware and software components of computing devices. For example, users of computing devices may submit service requests to a support platform to troubleshoot and remediate issues with hardware and software components of computing devices. Such requests may be for servicing under a warranty or other type of service contract offered by the support platform to users of the computing devices.

### SUMMARY

Illustrative embodiments of the present disclosure provide techniques for conditional tracing of operation flows executing on information technology assets.

In one embodiment, an apparatus comprises at least one processing device comprising a processor coupled to a memory. The at least one processing device is configured to generate, for one or more operations of an operation flow executing in an information technology asset, a first set of traces and a second set of traces, the second set of traces having more detail than the first set of traces, and to maintain, while the one or more operations of the operation flow are executing, the second set of traces in a trace buffer allocated for the operation flow, and to determine whether one or more designated conditions are detected during execution of the one or more operations of the operation flow. The at least one processing device is further configured, responsive to detecting at least one of the one or more designated conditions, to save the second set of traces maintained in the trace buffer allocated for the operation flow in a persistent data store. The at least one processing device is further configured, responsive to not detecting any of the one or more designated conditions, to drop the trace buffer allocated for the operation flow and save the first set of traces in the persistent data store.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for conditional tracing of operation flows executing on information technology assets in an illustrative embodiment.

FIG. 2 is a flow diagram of an exemplary process for conditional tracing of operation flows executing on information technology assets in an illustrative embodiment.

FIG. 3 shows a storage system configured for conditional tracing of input-output flows in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

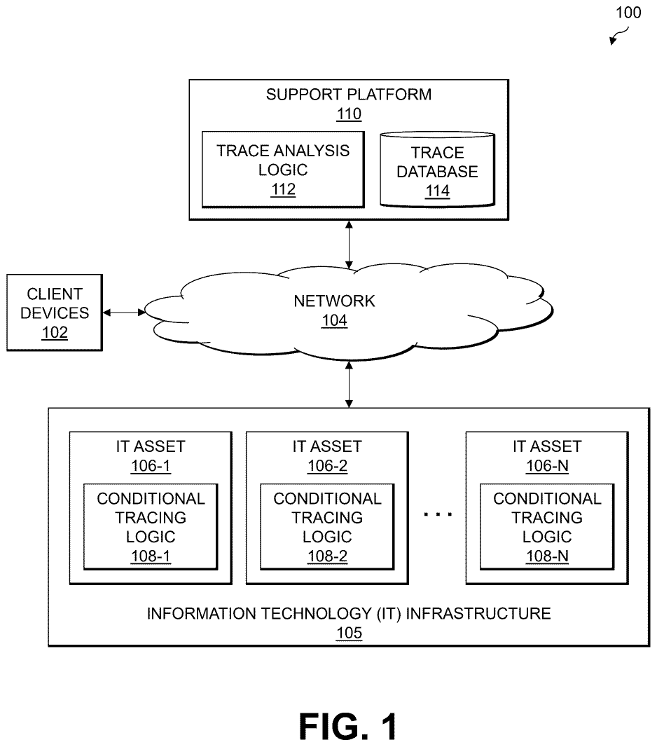

FIG. 1 shows an information processing system 100 configured in accordance with an illustrative embodiment. The information processing system 100 is assumed to be built on at least one processing platform and provides functionality for conditional tracing of operation flows executing on information technology (IT) assets. The information processing system 100 includes a set of client devices 102 which are coupled to a network 104. Also coupled to the network 104 is an IT infrastructure 105 comprising IT assets 106-1, 106-2, . . . 106-N (collectively, IT assets 106) implementing respective instances of conditional tracing logic 108-1, 108-2, . . . 108-N (collectively, conditional tracing logic 108), and a support platform 110 implementing trace analysis logic 112 and comprising trace database 114. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the support platform 110 is used for an enterprise system. For example, an enterprise may subscribe to or otherwise utilize the support platform 110 for managing the IT assets 106 of the IT infrastructure 105. For example, users of the client devices 102 may utilize the support platform 110 to troubleshoot and remediate issues encountered on the IT assets 106 (e.g., through debugging of traces generated by the IT assets 106, which may be stored in the trace database 114). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

Although not explicitly shown in FIG. 1, one or more input-output devices such as keyboards, displays or other types of input-output devices may be used to support one or more user interfaces to the support platform 110, as well as to support communication between the support platform 110 and other related systems and devices not explicitly shown.

The support platform 110 may be provided as a cloud service that is accessible by one or more of the client devices 102 to allow users thereof to perform issue analysis and remediation for the IT assets 106 of the IT infrastructure 105, where such issue analysis and remediation may include debugging of traces generated by the IT assets 106 utilizing trace analysis logic 112. In some embodiments, the client devices 102 are assumed to be associated with software developers, system administrators, IT managers or other authorized personnel responsible for managing the IT assets 106 of the IT infrastructure 105. In some embodiments, the IT assets 106 of the IT infrastructure 105 are owned or operated by the same enterprise that operates the support platform 110. In other embodiments, the IT assets 106 of the IT infrastructure 105 may be owned or operated by one or more enterprises different than the enterprise which operates the support platform 110 (e.g., a first enterprise provides support functionality for multiple different customers, businesses, etc.). Various other examples are possible.

The trace database 114 is configured to store and record various information that is utilized by the support platform 110 and the client devices 102. Such information may include, for example, traces which are generated by the IT assets 106. Although shown as being implemented internal to the support platform 110 in FIG. 1, the trace database 114 in some embodiments may be implemented external to the support platform 110 and possibly internal to one or more of the IT assets 106 of the IT infrastructure. The trace database 114 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

In some embodiments, the client devices 102 and/or the IT assets 106 of the IT infrastructure 105 may implement host agents that are configured for automated transmission of information with the support platform 110 (e.g., regarding system issues encountered while operating the IT assets 106 of the IT infrastructure 105). It should be noted that a “host agent” as this term is generally used herein may comprise an automated entity, such as a software entity running on a processing device. Accordingly, a host agent need not be a human entity.

The IT assets 106 and the support platform 110 in the FIG. 1 embodiment are assumed to be implemented using at least one processing device. Each such processing device generally comprises at least one processor and an associated memory, and implements one or more functional modules or logic for controlling certain features of the IT assets 106 and the support platform 110. In the FIG. 1 embodiment, the IT assets 106 implement conditional tracing logic 108 and the support platform 110 implements trace analysis logic 112. The conditional tracing logic 108 is configured to generate, for operations of operation flows executing in the IT assets 106, first and second sets of traces, where the second set of traces for each operation flow has more detail than the first set of traces for that operation flow. The traces, also referred to as logs, may include time series data or other metrics or information that is logged or collected by the IT assets 106 as the operation flows execute. The conditional tracing logic 108 is configured to maintain per-operation flow buffers for the second sets of traces (e.g., in memory), and to determine whether any designated conditions are detected while the operation flows are executing. The designated conditions may include, for example, detecting failure or error of one or more operations in an operation flow, detecting that one or more operations in an operation flow are taking more than a designated threshold amount of time to complete, detecting a system issue (e.g., system panic), etc. If any of such conditions are detected for a given operation flow, the conditional tracing logic 108 will save the second set of traces for the given operation flow from its associated flow-specific buffer to a persistent data store. If none of such conditions are detected for the given operation flow, the conditional tracing logic 108 may drop the flow-specific buffer associated with the given operation flow and instead save the first set of traces generated for the given operation flow to the persistent data store. It should be understood that the term “drop” is intended to be broadly construed, and may include, for example, deleting, marking for deletion, permitting overwriting thereof, etc. The trace analysis logic 112 is configured to perform debugging or other analysis utilizing the traces saved to the persistent data store.

At least portions of the conditional tracing logic 108 and the trace analysis logic 112 may be implemented at least in part in the form of software that is stored in memory and executed by a processor.

It is to be appreciated that the particular arrangement of the client devices 102, the IT infrastructure 105, and the support platform 110 illustrated in the FIG. 1 embodiment is presented by way of example only, and alternative arrangements can be used in other embodiments. As discussed above, for example, the support platform 110 (or portions of components thereof, such as one or more of the trace analysis logic 112 and the trace database 114) may in some embodiments be implemented internal to the IT infrastructure 105.

The support platform 110 and other portions of the information processing system 100, as will be described in further detail below, may be part of cloud infrastructure.

The support platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, and the support platform 110 or components thereof (e.g., the conditional tracing logic 108, the trace analysis logic 112 and the trace database 114) may be implemented on respective distinct processing platforms, although numerous other arrangements are possible. For example, in some embodiments at least portions of the support platform 110 and one or more of the client devices 102 and/or the IT assets 106 are implemented on the same processing platform. A given client device 102 can therefore be implemented at least in part within at least one processing platform that implements at least a portion of the support platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106 and the support platform 110, or portions or components thereof, to reside in different data centers. Numerous other distributed implementations are possible. The support platform 110 can also be implemented in a distributed manner across multiple data centers.

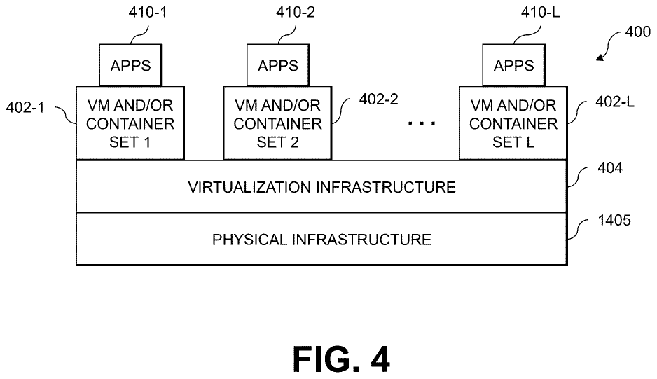

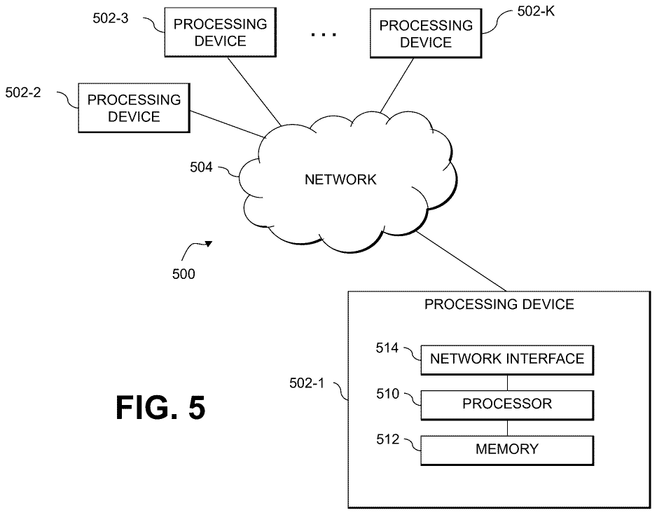

Additional examples of processing platforms utilized to implement the support platform 110 and other components of the information processing system 100 in illustrative embodiments will be described in more detail below in conjunction with FIGS. 4 and 5.

It is to be understood that the particular set of elements shown in FIG. 1 for conditional tracing of operation flows executing on IT assets is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

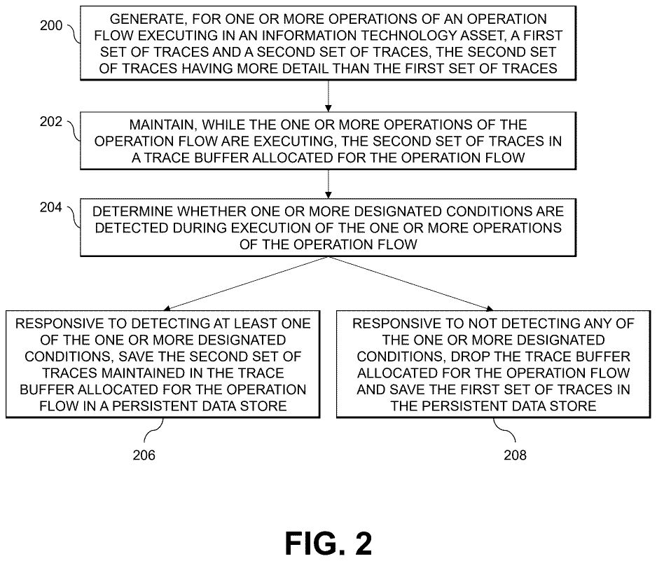

An exemplary process for conditional tracing of operation flows executing on IT assets will now be described in more detail with reference to the flow diagram of FIG. 2. It is to be understood that this particular process is only an example, and that additional or alternative processes for conditional tracing of operation flows executing on IT assets may be used in other embodiments.

In this embodiment, the process includes steps 200 through 208. These steps are assumed to be performed by the IT assets 106 and/or the support platform 110 utilizing the conditional tracing logic 108 and/or the trace analysis logic 112. The process begins with step 200, generating, for one or more operations of an operation flow executing in an IT asset, a first set of traces and a second set of traces, the second set of traces having more detail than the first set of traces. The IT asset may comprise a storage system, the operation flow may comprise an IO flow, and the one or more operations may comprise IO operations.

In step 202, the second set of traces are maintained, while the one or more operations of the operation flow are executing, in a trace buffer allocated for the operation flow. The trace buffer may be maintained in memory of the information technology asset.

In step 204, a determination is made as to whether one or more designated conditions are detected during execution of the one or more operations of the operation flow. Responsive to detecting at least one of the one or more designated conditions, the second set of traces maintained in the trace buffer allocated for the operation flow are saved in a persistent data store in step 206. Responsive to not detecting any of the one or more designated conditions, the trace buffer allocated for the operation flow is dropped and the first set of traces is saved in the persistent data store in step 208. Saving the second set of traces in the persistent data store may include providing the second set of traces to a support platform providing support services for the IT asset.

The one or more designated conditions may comprise: detecting a failure of at least one of the one or more operations of the operation flow; detecting an error encountered while executing at least one of the one or more operations of the operation flow; detecting that at least one of the one or more operations of the operation flow is taking longer than a designated threshold amount of time to complete; and detecting a system error encountered on the IT asset The designated threshold amount of time to complete may be based at least in part on an operation type of said at least one operation, one or more quality of service levels associated with the operation flow, etc. Responsive to detecting that at least one of the one or more operations of the operation flow is taking longer than the designated threshold amount of time to complete, the FIG. 2 process may further include saving one or more additional sets of traces generated for one or more operations of one or more additional operation flows that are concurrently executing on the IT asset. The one or more additional operation flows may be identified based at least in part on tags associated with the operation flow and each of the one or more additional operation flows. The operation flow and the one or more additional operation flows that are concurrently executing on the IT asset may comprise respective IO flows having IO operations directed to at least one of a same target storage volume and a same region of a target storage device. Responsive to detecting the system error encountered on the IT asset, the FIG. 2 process may further include saving one or more additional sets of traces generated for one or more operations of one or more additional operation flows that are concurrently executing on the IT asset to the persistent data store.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments provide technical solutions for conditional tracing which provide maximal debuggability of issues encountered on IT assets, without incurring a significant performance or resource penalty. In order to perform troubleshooting and remediation of issues encountered on IT assets, detailed traces (also referred to as logs) are critical. For example, detailed traces on a per-IO basis in storage systems is something that is critical for debugging information post-fact when a data inconsistency or other issue occurs on the storage system. Due to the scale of IO operations per second (IOPS) and the details required, in some cases only basic or limited “default” traces are maintained for each IO, where the default traces are limited to less detail than would be required for a full investigation. Storing detailed traces for every IO in a storage system is not practical due to various considerations, including the large amount of storage capacity necessary to hold detailed trace information for every IO, and the high processing cost of handling such high frequency detailed traces (e.g., central processing unit (CPU) or other processing resources, writing to disk, etc.). These factors usually limit tracing verbosity, and prevent a level of tracing that is desirable for cases where some issue has happened. Instead, there is usually a tradeoff where a storage system or other IT asset will utilize either short-lived very detailed traces or long-lived but low frequency traces. To solve these and other technical challenges, illustrative embodiments provide technical solutions for conditional tracing that allows for reaching any desired level of tracing and debuggability while minimizing performance impact and resource utilization.

Detailed traces may be critical for debugging of system issues encountered on IT assets. For example, detailed traces on a per-IO basis for storage systems can be critical for debugging information post-fact when a data consistency or other issue occurs. Issues such as data inconsistencies, performance degradations, etc., can arise from highly complex interactions and very subtle and delicate consequences of the storage system or other IT asset. Without detailed traces, often the only way to proceed is to provide special builds that increase the logging details to wait for reproduction of the issues. Even then, sometimes issues take many machine hours to reproduce. Other times, countless engineer hours must be invested in order to investigate issues using incomplete information (e.g., default, regular or otherwise limited traces) requiring looking through code to piece together possible causes for issues without having the complete picture that detailed traces could provide.

Due to the scale of IOPS and the amount of detail required, storing traces with such detailed information for each IO (or IO flow) in a storage system is not practical. Instead, the storage system is usually limited to generating and maintaining default traces with less detail than would be required for a full investigation (e.g., due to the large amount of storage capacity needed to store more detailed traces for each IO or IO flow, the performance impact of generating more detailed traces and writing such detailed traces to disk, etc.). These and other factors usually limit tracing verbosity and prevent a level of tracing that is desirable for cases when issues occur. Conventional approaches to tracing thus have a tradeoff between either a high rate of highly detailed but very short-lived traces that are non-persistent, or having long-lived traces that are not detailed enough for debugging investigations. The technical solutions described herein provide techniques which enable conditional tracing that allow for reaching any level of tracing and debuggability while minimizing performance impacts and resource utilization.

The technical solutions, in some embodiments, leverage the idea that most of the time detailed traces are unnecessary (e.g., as in most cases, IO operations, IO flows or other operations on a storage system or other IT asset complete successfully). It is mostly during failure or when an error or other irregular situation occurs that the traces are really required. This information, however, is only available in hindsight. In conventional approaches, storage systems or other IT assets must choose ahead of time whether to utilize default (e.g., regular or limited) or detailed tracing. For example, many storage systems must choose ahead of time to either turn off detailed tracing and not have the detailed traces when needed to save resources (e.g., that would be used to store and produce the detailed traces), or to have detailed tracing always on and pay a penalty (e.g., as, most of the time, the detailed traces are not needed or used).

In some embodiments, the technical solutions have detailed traces separated from regular or default traces, where a specific function call is used for the detailed tracing. The detailed traces are maintained in some IO or other flow-related buffer (e.g., with near-zero price, from a resource utilization and performance impact perspective) and are only flushed to disk when the IO or other flow is completed in some irregular way (e.g., in response to detecting one or more designated conditions, such as with operations with errors or a long delay, system panic, etc.). If an IO or other flow is completed successfully, the buffer for the IO or other flow may be dropped. Thus, the technical solutions described herein provide mechanisms that allow for detailed traces to only be persistently saved in response to detecting one or more designated conditions (e.g., corresponding to when something goes wrong). The technical solutions described herein thus allow the best of both worlds—having the detailed trace data when needed, but not spending the storage capacity and other resources to maintain the detailed trace data when it will not be used. This advantageously can minimize CPU usage and other resources for producing those traces. It should be noted that conditional detailed traces are volatile traces, and are less applicable for certain types of issues (e.g., silent data corruption investigations, or other corruptions that are not recognized until a long time after the corruption has happened). For such investigations, another type of traces (e.g., persistent traces) may be used.

The technical solutions described herein introduce a dedicated type of traces, referred to as “detailed” traces. Detailed traces have a separate system call or macro from regular or default tracing. A developer or other user is responsible for adding regular or default traces (e.g., which are printed or otherwise produced unconditionally) or detailed traces in the code according to their discretion (e.g., the developer or other user may define the specific conditions under which the detailed traces are generated and persisted). Each flow (e.g., an IO or other operation flow) will have a defined “start” location and all the traces will be tagged with a flow so that they can be correlated.

In an example storage system implementation, the start of a User Mode Thread (UMT) that processes IO (or triggers the flow of IO or other operations) will be the beginning of the flow, such that in these cases no explicit “begin” call is required. UMT threads an example of a lightweight thread model in which user-mode threads do fast context-switches in the user-mode without the overhead of a full-blown kernel mode context-switch. On such UMT initialization, the detailed tracing mechanism can allocate the necessary buffers and generate a flow identifier (“flow ID”) which will be used in all detailed traces generated from this flow. When the UMT completes, if it has not been marked as “unsuccessful” (and no other designated system-wide condition is triggered), then the detailed traces will be dropped (regular or default traces, which are more limited than the detailed traces, may still be maintained). Otherwise, the detailed traces will be flushed to disk upon UMT teardown. In cases where a flow is not part of a UMT lifecycle, a separate application programming interface (API) can be used which will allocate the buffers and generate a flow ID. It is noted that in such cases (e.g., when a flow involves a few UMTs or threads), some dedicated structure flow control block (CB) is usually applied to keep the context of the flow. Accordingly, the flow ID and buffers may be maintained inside this structure or context. All subsequent detailed traces that are then called supply this flow ID. Upon flow completion, an API that “finalizes” the flow can be called, similar to UMT teardown with the “result” of the flow (e.g., success or failure).

At the flow completion, which may be normal/success or error/failure, an evaluation is performed as to whether one or more designated conditions have been met. If one or more of such designated conditions have been met, then the detailed traces may be kept (e.g., flushed to disk from the temporary buffer) or may be dropped. The designated conditions (e.g., which trigger “saving” of the detailed traces) may include: detecting any type of error or abnormal flow completion (e.g., data inconsistency); detecting a long processing time (e.g., where a “long” processing time may be based on various thresholds associated with different Quality of Service (QoS) levels for specific IO or other operation types); detecting a system-wide issue or panic (e.g., where, in such cases, detailed traces for all active IOs or other flows may be maintained); etc.

The technical solutions may, in some embodiments, define different levels of flushes or other saving of the detailed traces based on which designated conditions have been triggered. For example, if a flow takes an abnormally long amount of time (e.g., as defined by some threshold for that flow type), it is often in other concurrently running flows that “clues” or reasons for the abnormally long process time can be learned. In such cases, the designated condition may trigger a request to save or maintain detailed traces for at least some (and potentially all) of the concurrently running flows (e.g., based on a set of “tags” associated with such concurrently running flows, where the tags may identify other IOs or flows operating on the same storage volume, region of metadata, target device, etc.).

Each flow will have its own buffer that is large enough to hold detailed traces for the entirety of that flow. This allows each flow to produce the detailed traces in a lockless manner and with a minimal CPU performance penalty due to locks. Further, since the detailed traces are stored in memory, the performance hit of writing the conditional traces is minimized as well. At the different possible completion points, a flow can be marked as unsuccessful to trigger a flush of the detailed traces for the flow to disk. If, on the other hand, the flow is marked as having completed successfully, then the detailed traces are not persisted and can be dropped. When the system encounters a panic condition, the system may consider all ongoing flows as being unsuccessful and will implicitly end all of them triggering a flush of the detailed traces for all the ongoing flows. This ensures that, at the moment of the panic condition, there is an as complete as possible snapshot of the ongoing operations of the system for maximum debuggability.

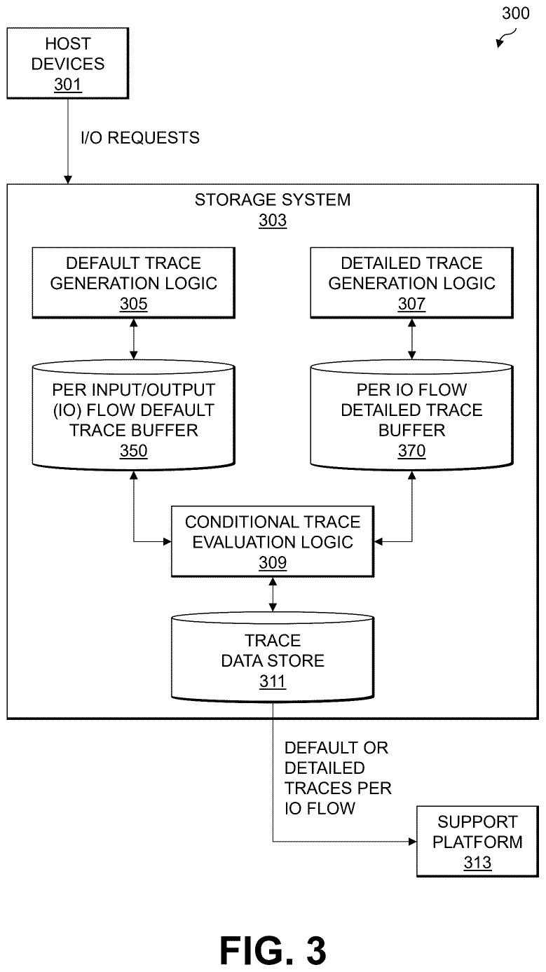

FIG. 3 shows a system 300 configured for conditional tracing, where the system 300 includes host devices 301 that submit IO requests to a storage system 303. The storage system 303 processes the IO requests, and during such processing utilizes default trace generation logic 305 to generate limited default traces and detailed trace generation logic 307 to generated more detailed traces as the IO operations of IO flows are executed. While the IO flows are executing in the storage system 303, the limited default traces are stored in a per IO flow default trace buffer 350 and the more detailed traces or stored in a per IO flow detailed trace buffer 370.

The storage system 303 utilizes conditional trace evaluation logic 309 to determine, for each IO flow, whether one or more designated conditions have been detected. As discussed above, such designated conditions may indicate whether a particular IO flow has encountered an error or has completed successfully. The error condition may indicate failure of an IO flow, determining that the IO flow or one or more IO operations that are part of the IO flow are taking more than a designated threshold time to complete (e.g., where a long processing time may be indicative of an error in that IO flow, which may be based on other concurrently executing IO flows), etc. The error condition may also or alternatively indicate a system-wide issue on the storage system 303 (e.g., a panic condition).

Depending on the specific conditions which are detected, the conditional trace evaluation logic 309 determines whether to keep or maintain the default (limited) or more detailed traces for each IO flow. For example, if a given IO flow is completed successfully, and if no other concurrently executing IO flow has a detected condition which triggers saving of detailed traces for the given IO flow, then the limited default traces (e.g., from the per IO flow default trace buffer 350) may be maintained in a trace data store 311 and potentially provided to the support platform 313. If the given IO flow encounters an error (e.g., has not completed successfully), or if another concurrently executing IO flow has a detected condition which triggers saving of detailed traces for the given IO flow, then the more detailed traces (e.g., from the per-IO flow detailed trace buffer 370) may be maintained in the trace data store 311 and potentially provided to the support platform 313. The conditional trace evaluation logic 309 may also be configured to detect certain conditions (e.g., a panic condition, an error or failure of a target storage volume or device, etc.) which trigger saving of the more detailed traces for all or some subset of affected IO flows (e.g., those involving the target storage volume or device which has encountered the error or failure), and will save detailed traces for all or the subset of the affected IO flows in the trace data store 311.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for conditional tracing of operation flows executing on IT assets will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100 in FIG. 1. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for conditional tracing of operation flows executing on IT assets as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to generate, for one or more operations of an operation flow executing in an information technology asset, a first set of traces and a second set of traces, the second set of traces having more detail than the first set of traces;
to maintain, while the one or more operations of the operation flow are executing, the second set of traces in a trace buffer allocated for the operation flow;
to determine whether one or more designated conditions are detected during execution of the one or more operations of the operation flow;
responsive to detecting at least one of the one or more designated conditions, to save the second set of traces maintained in the trace buffer allocated for the operation flow in a persistent data store; and
responsive to not detecting any of the one or more designated conditions, to drop the trace buffer allocated for the operation flow and save the first set of traces in the persistent data store.

2. The apparatus of claim 1 wherein the information technology asset comprises a storage system, the operation flow comprises an input-output flow, and the one or more operations comprise input-output operations.

3. The apparatus of claim 1 wherein the trace buffer is maintained in memory of the information technology asset.

4. The apparatus of claim 1 wherein saving the second set of traces in the persistent data store comprises providing the second set of traces to a support platform providing support services for the information technology asset.

5. The apparatus of claim 1 wherein a given one of the one or more designated conditions comprises detecting a failure of at least one of the one or more operations of the operation flow.

6. The apparatus of claim 1 wherein a given one of the one or more designated conditions comprises detecting an error encountered while executing at least one of the one or more operations of the operation flow.

7. The apparatus of claim 1 wherein a given one of the one or more designated conditions comprises detecting that at least one of the one or more operations of the operation flow is taking longer than a designated threshold amount of time to complete.

8. The apparatus of claim 7 wherein the designated threshold amount of time to complete is based at least in part on an operation type of said at least one operation.

9. The apparatus of claim 7 wherein the designated threshold amount of time to complete is based at least in part on one or more quality of service levels associated with the operation flow.

10. The apparatus of claim 7 wherein, responsive to detecting the given designated condition, the at least one processing device is further configured to save one or more additional sets of traces generated for one or more operations of one or more additional operation flows that are concurrently executing on the information technology asset.

11. The apparatus of claim 10 wherein the one or more additional operation flows are identified based at least in part on tags associated with the operation flow and each of the one or more additional operation flows.

12. The apparatus of claim 10 wherein the operation flow and the one or more additional operation flows that are concurrently executing on the information technology asset comprise respective input-output flows having input-output operations directed to at least one of a same target storage volume and a same region of a target storage device.

13. The apparatus of claim 1 wherein a given one of the one or more designated conditions comprises detecting a system error encountered on the information technology asset.

14. The apparatus of claim 13 wherein, responsive to detecting the given designated condition, the at least one processing device is further configured to save one or more additional sets of traces generated for one or more operations of one or more additional operation flows that are concurrently executing on the information technology asset to the persistent data store.

15. A computer program product comprising a non-transitory processor-readable storage medium having stored therein program code of one or more software programs, wherein the program code when executed by at least one processing device causes the at least one processing device:
to generate, for one or more operations of an operation flow executing in an information technology asset, a first set of traces and a second set of traces, the second set of traces having more detail than the first set of traces;
to maintain, while the one or more operations of the operation flow are executing, the second set of traces in a trace buffer allocated for the operation flow;
to determine whether one or more designated conditions are detected during execution of the one or more operations of the operation flow;
responsive to detecting at least one of the one or more designated conditions, to save the second set of traces maintained in the trace buffer allocated for the operation flow in a persistent data store; and
responsive to not detecting any of the one or more designated conditions, to drop the trace buffer allocated for the operation flow and save the first set of traces in the persistent data store.

16. The computer program product of claim 15 wherein the information technology asset comprises a storage system, the operation flow comprises an input-output flow, and the one or more operations comprise input-output operations.

17. The computer program product of claim 15 wherein the one or more designated conditions comprise:
detecting a failure of at least one of the one or more operations of the operation flow;
detecting an error encountered while executing at least one of the one or more operations of the operation flow;
detecting that at least one of the one or more operations of the operation flow is taking longer than a designated threshold amount of time to complete; and
detecting a system error encountered on the information technology asset.

18. A method comprising:
generating, for one or more operations of an operation flow executing in an information technology asset, a first set of traces and a second set of traces, the second set of traces having more detail than the first set of traces;
maintaining, while the one or more operations of the operation flow are executing, the second set of traces in a trace buffer allocated for the operation flow;
determining whether one or more designated conditions are detected during execution of the one or more operations of the operation flow;
responsive to detecting at least one of the one or more designated conditions, to save the second set of traces maintained in the trace buffer allocated for the operation flow in a persistent data store; and
responsive to not detecting any of the one or more designated conditions, to drop the trace buffer allocated for the operation flow and save the first set of traces in the persistent data store;
wherein the method is performed by at least one processing device comprising a processor coupled to a memory.

19. The method of claim 18 wherein the information technology asset comprises a storage system, the operation flow comprises an input-output flow, and the one or more operations comprise input-output operations.

20. The method of claim 18 wherein the one or more designated conditions comprise:
detecting a failure of at least one of the one or more operations of the operation flow;
detecting an error encountered while executing at least one of the one or more operations of the operation flow;
detecting that at least one of the one or more operations of the operation flow is taking longer than a designated threshold amount of time to complete; and
detecting a system error encountered on the information technology asset.
